(19) United States
(12) Patent Application Publication
(10) Pub. No.: US 2015/0095081 A1
(43) Pub. Date: Apr. 2, 2015

(54) STACKABLE STRATEGIES

(71) Applicant: Avaya Inc., Basking Ridge, NJ (US)

(72) Inventor: Robert C. Steiner, Broomfield, CO (US)

(73) Assignee: Avaya Inc., Basking Ridge, NJ (US)

(21) Appl. No.: 14/043,296

(22) Filed: Oct. 1, 2013

(51) Int. Cl. G06Q 10/06

(52) U.S. Cl. CPC G06Q 10/06316; G06Q 10/063114
USPC 705/7.15

(57) ABSTRACT

A contact center is provided with the ability to easily modify, change, append, delete, or create new strategies. Contact center strategies are provided with the ability to be stacked on one another, thereby creating a combination strategy. The combination strategy may hierarchically represent and perform the individual strategies that constitute the combination strategy. Moreover, individual strategies can be removed, added, or replaced with other individual strategies, thereby providing a simple and efficient way for changing the behavior of the combination strategy.

### FIELD OF THE DISCLOSURE

The present disclosure is generally directed toward communications and more specifically toward contact centers.

### BACKGROUND

In a contact center, tasks are specific operations that are performed by a work assignment engine. Examples of tasks that are often performed by a work assignment engine include, without limitation, score work, score resource, qualify work, qualify resource, match work and resource, queue, de-queue, remove, etc.

The contact center's work assignment engine may process an enormous number of tasks over time, following certain rules. With the advent of large or complicated strategies, some strategies may be lost or in conflict with other strategies being implemented by the work assignment engine. It is also expensive to rewrite or build a new strategy or set of strategies. Today, adding a new rule to apply to all strategies is a manual process that requires independently changing each strategy to include the newly-added rule.

### SUMMARY

It is with respect to the above-described limitations that embodiments of the present disclosure were contemplated. Specifically, a work assignment engine capable of executing stacked strategies is provided.

In accordance with at least some embodiments of the present disclosure, a strategy is a collection of task mappings where rules or policies are used to determine a priority with which tasks are executed or processed. In the context of a contact center, a work assignment engine is configured to execute these strategies. As contact center systems become more complex, a new architecture needs to be implemented to efficiently handle the processing of strategies when multiple strategies need to be executed or changes need to be made to the rule set of a strategy.

Using a non-limiting example of a preferred agent, today an administrator would first add a rule to all existing strategies in a contact center, which could be more than ten or twenty strategies. What if the administrator misses one of the strategies or accidentally enters the rule into a strategy incorrectly? Embodiments of the present disclosure can address the above-noted shortcomings by implementing a strategy stacking. More specifically, a strategy stacking scheme is disclosed in which a contact center administrator is provided with the flexibility to easily and efficiently update and/or fine-tune strategies of a work assignment engine.

In accordance with at least some embodiments, strategy stacking is a way to manage the execution of tasks beyond a simple replacement of those tasks. Strategy stacking enables changes to be made to the behavior of work assignment algorithms based on order and/or mapping rules. In some embodiments, there are two different forms of strategy stacking that can be employed for a work assignment engine: (1) static and (2) dynamic.

In accordance with at least some embodiments of the present disclosure, static strategy stacking comprises a solution whereby a rule set or rule change is applied to all strategies in a contact center during initialization and/or prior to compiling. As a non-limiting example of static strategy stacking, a contact center administrator may desire to implement a preferred agent algorithm that causes a preferred agent to be selected for a contact if the customer associated with the contact has specifically requested the preferred agent. In this example, the contact center administrator may not want to individually add the preferred agent rule to each strategy defined for a work assignment engine. Accordingly, embodiments of the present disclosure enable the preferred agent rule to be added to the work assignment engine as a simple declaration in any source file. This causes the preferred agent rule to be inserted into each strategy at compile time so that each strategy can have that rule executed by the work assignment engine. As can be appreciated, a static strategy stacking may further be modified by dynamic strategy stacking.

Dynamic strategy stacking is a solution where the contact center administrator decides, after compile time, to add rules to or remove rules from one, some, or all strategies in a contact center. Placing the rules in a different order may also qualify as a dynamic strategy stacking. In some embodiments, rules can be added or removed to some or all of the strategies for attribute sets or resources (e.g., agents). As a non-limiting example of dynamic strategy stacking, a contact center administrator may want to add a night mode to all the strategies executed by a work assignment engine. To enable this night mode of operation, a Night Strategy may be created with a rule set for the night mode may say something like “If a contact is received between 5:00 PM and 8:00 AM, the contact is routed to the Night Interactive Voice Response (IVR)—otherwise, the contact is routed normally. To achieve this night mode behavior, dynamic strategy stacking may be employed to administratively “insert” the Night Strategy before all other strategies currently in the system (e.g., stack the Night Strategy with all other existing strategies). The administration may be as simple as a dialog that enables a contact center administrator to select the modification strategy from a list (e.g., customer chooses Night Strategy), then a check box to have the work assignment engine apply the Night Strategy before or after the existing strategies with which the Night Strategy is being stacked. In this particular embodiment of dynamic strategy stacking, none of the strategies are modified; rather, only the run time execution of the work assignment engine is changed to execute the Night Strategy before the normal strategy.

In accordance with at least some embodiments, contact center entities (e.g., resources and/or agents) may have their own private rules or strategies. These rules would be custom composed for that entity and work with the standard strategy. For example, an agent may prefer to take critically important work in the morning but may want to pick and choose work to do in the afternoon. This particular private rule may be implemented as a dynamically stacked strategy that is executed after other strategies by the work assignment engine.

Another aspect of the present disclosure is to enable a contact center supervisor to dynamically change the strategies for one or more agents or resources.

In accordance with at least some embodiments of the present disclosure, a method is provided which generally comprises:

stacking a first strategy with a second strategy to create a stacked strategy, wherein the first strategy corresponds to a first set of executable tasks performable by a work assignment engine of a contact center and the second strategy corresponds to a second set of executable tasks performable by the work assignment engine; and executing the stacked strategy with the work assignment engine according to an order in which the first strategy is stacked with the second strategy.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting a plurality of strategies in accordance with embodiments of the present disclosure;

FIG. 3A depicts a first configuration of a stacked strategy in accordance with embodiments of the present disclosure;

FIG. 3B depicts a second configuration of a stacked strategy in accordance with embodiments of the present disclosure;

FIG. 3C depicts a third configuration of a stacked strategy in accordance with embodiments of the present disclosure;

FIG. 3D depicts a fourth configuration of a stacked strategy in accordance with embodiments of the present disclosure;

FIG. 3E depicts a fifth configuration of a stacked strategy in accordance with embodiments of the present disclosure;

FIG. 4 depicts a first strategy stacking method in accordance with embodiments of the present disclosure;

FIG. 5 depicts a second strategy stacking method in accordance with embodiments of the present disclosure; and

FIG. 6 depicts a third strategy stacking method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

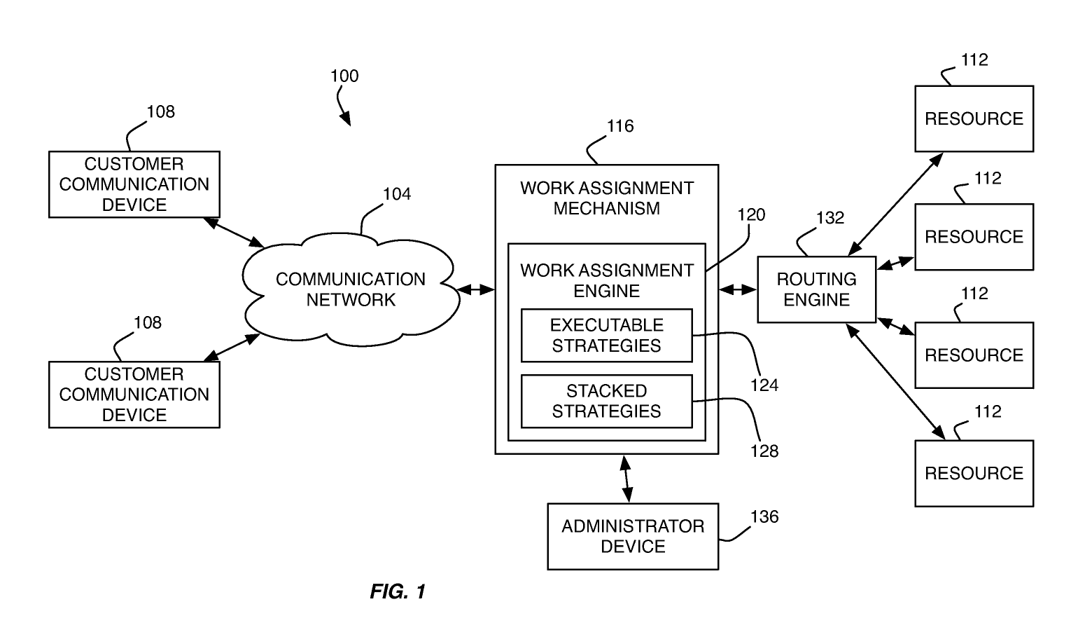

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and Ser. No. 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

More specifically, the work assignment engine 120 comprises executable strategies 124 that, when executed, enable the work assignment engine 120 to determine which of the plurality of processing resources 112 is qualified and/or eligible to receive the work item and further determine which of the plurality of processing resources 112 is best suited to handle the processing needs of the work item. In situations of work item surplus, the work assignment engine 120 can also make the opposite determination (i.e., determine optimal assignment of a work item resource to a resource). In some embodiments, the work assignment engine 120 is configured to achieve true one-to-one matching by utilizing bitmaps/tables and other data structures.

In accordance with at least some embodiments of the present disclosure, the work assignment engine 120 may be configured to execute one or several executable strategies 124 to make work assignment decisions. As will be discussed in further detail herein, the work assignment engine 120 may comprise a plurality of executable strategies 124, where one or more of the executable strategies 124 include one or many tasks that are performed by the work assignment engine 120 during execution of the executable strategy 124. The order or manner in which the tasks of a strategy 124 are executed by the work assignment engine 120 may be defined by rules or policies, which may also be included in the executable strategy 120. Non-limiting examples of tasks that can be included in an executable strategy 124 include, without limitation, any of the following actions:
For a Resource: Add, Remove, Change a State (e.g., READY, ON DUTY, NOT READY, etc.), Update, Enable, Disable, Qualify Resource, Qualify Match, Score Resource, Begin, Finish, Set New Best, Enqueue, Dequeue, Accept, Reject, and Timeout
For a Work Item: Add, Remove, Update, Cancel, Begin, Finish, Next Evaluation, Find Resource, Qualify Work, Qualify Match, Score Work, Set New Best, Enqueue, Dequeue, Accept, Reject, Requeue, Ready, Not-Ready, Complete, and Time-Out
For a Service: Add, Remove, Update, and Enable
For Determining a Best Match: Assign Work To Resource, and Determine Well-Matched
For Determining Context: Heartbeat Failure, Customer Score, Custom Qualify, Custom Well Matched, Ready Res Service Capabilities, Not Ready Res Service Capabilities, Begin Resume, Begin Service Enable, Metric Sample, Intrinsic Sample, Intrinsic Sample All, Compute Requeue Metrics, Compute Enqueue Metrics, Compute Dequeue Metrics, Add Existing, Completed, Comput Rejected Metrics, Compute Accepted Metrics, Accepted, Rejected, Requeued, Compute Abandoned Metrics, and Compute Completed Metrics

As will be discussed in further detail herein, one, some, or all of the executable strategies 124 may be stacked with one another (e.g., combined together) to create a stacked strategy 128. FIG. 1 shows that the work assignment engine 120 may comprise a plurality of stacked strategies 128, which correspond to hierarchically-ordered executable strategies 124. In some embodiments, the stacked strategies 128 may be constructed via an administrator device 136 in either a static or dynamic fashion. In some embodiments, a user interface may be exposed to a user of the administrator device 136 that enables the user (e.g., contact center administrator) to create and modify the stacked strategies 128.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

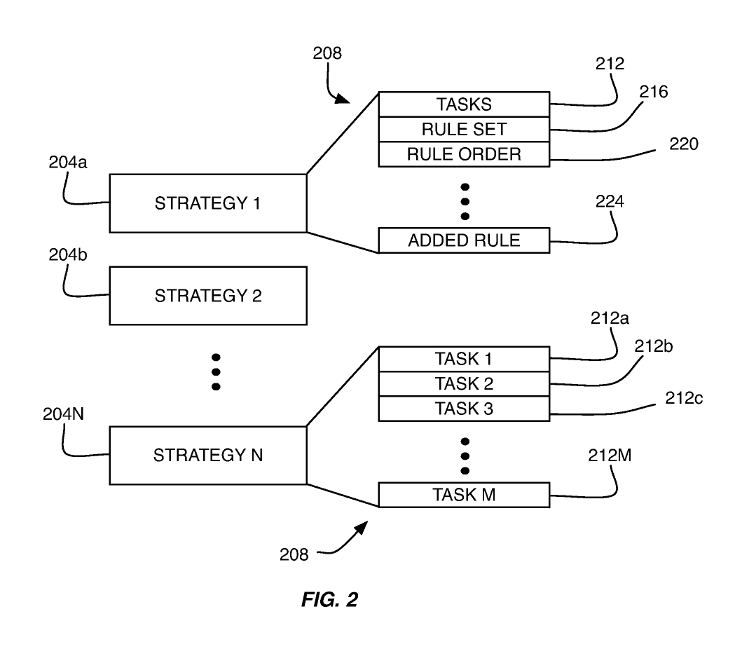

With reference now to FIG. 2, additional details of a strategy 204a-N, which may correspond to one or more of the executable strategies 124, will be described in accordance with at least some embodiments of the present disclosure. As shown in FIG. 2, a strategy 204 may comprise a number of components 208 that enable execution of the strategy 204 by the work assignment engine 120. In some embodiments, a strategy 204 may include one or more tasks 212, one or more rules sets 216, a rule order 220, and one or more added rules 224.

As discussed above, the strategy 212 may comprise any number of tasks 212 that can be performed concurrently or sequentially when executing a strategy 204. The manner, order, or priority with which the tasks 212 are performed may be dictated by the rules laid out in the rule set 216. For instance, the rule set 216 may comprise conditions under which a task 212 should or should not be performed. The conditions defined within a rule set 216 may be related to whether or not other tasks have already been performed, the results of executing such tasks, external conditions (e.g., contact center state, resource status, etc.), and combinations thereof. The rule order 220 may define the order in which certain rule sets 216 are analyzed and rules can be added 224 by an administrator operating the administrator device 136.

Alternatively or additionally, a strategy 204 may only comprise a number of tasks 212a-M that are sequentially performed during execution of the strategy. More specifically, the tasks 212a-M of a strategy 204 may be hierarchically ordered such that a first task 212a in the set of tasks is performed prior to a second task 212b, which is performed prior to a third task 212c, and so forth. In this way, the rules for performing the tasks 212a-M are inherently defined by the ordering of the tasks 212a-M in the strategy 204. As will be described in further detail herein, the ordering of tasks 212a-M and/or the rule sets 216 defining when tasks are performed may be administratively adjusted for a single strategy 204 or multiple strategies 204.

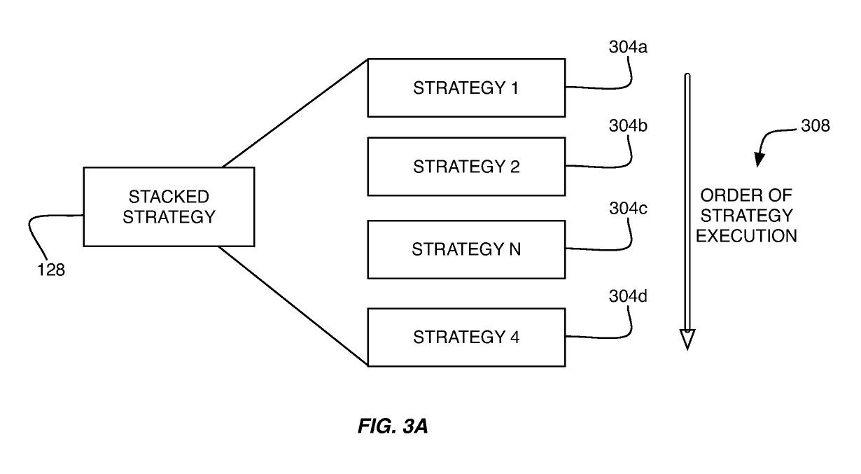

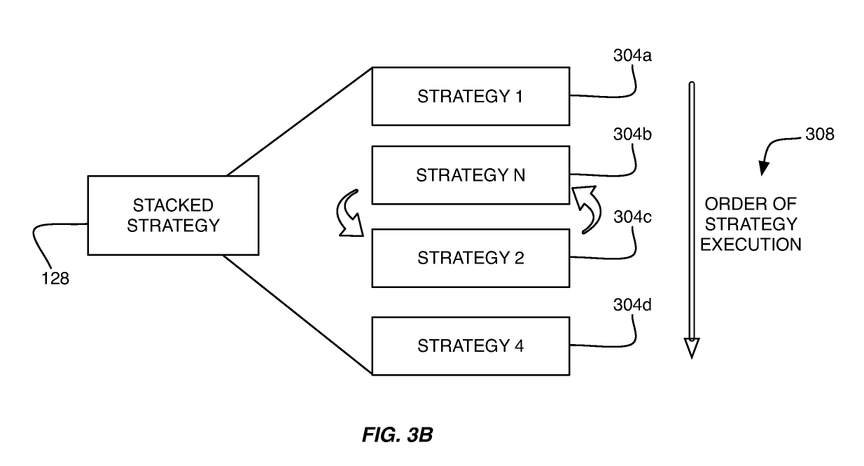

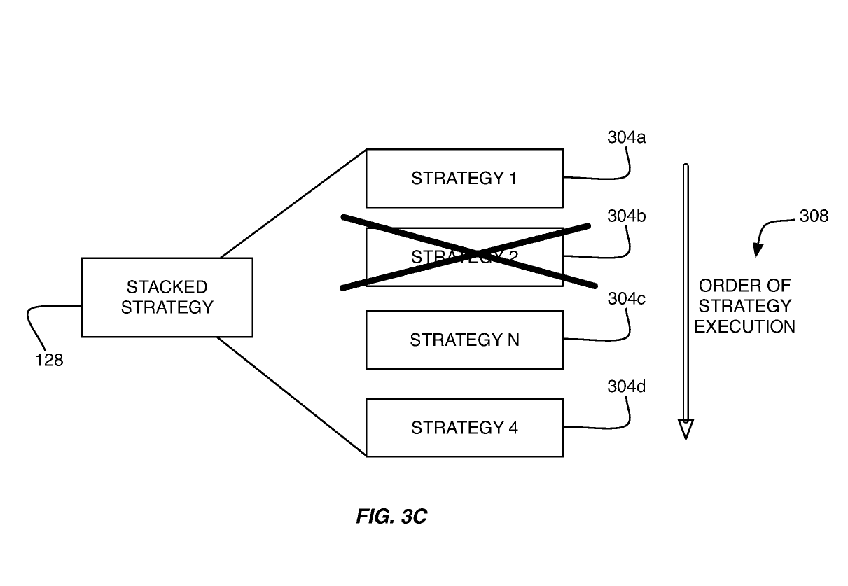

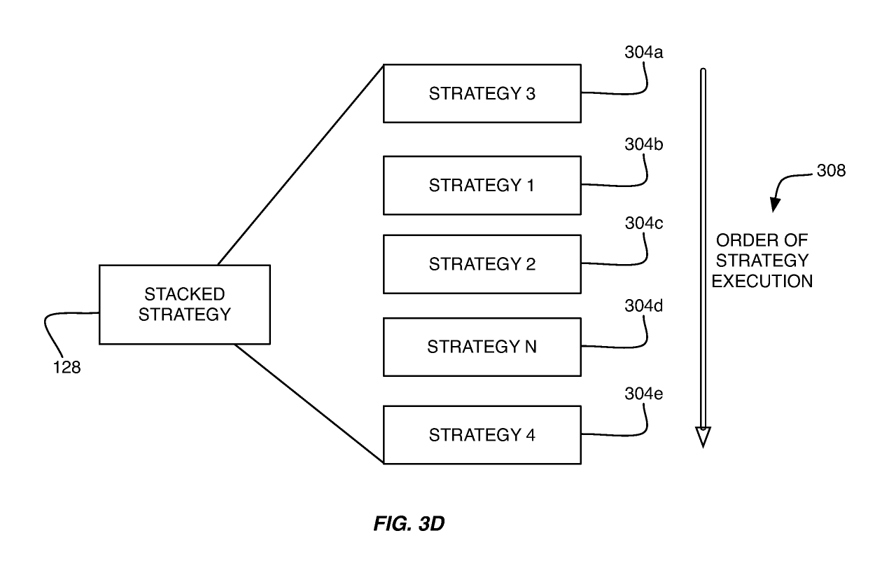

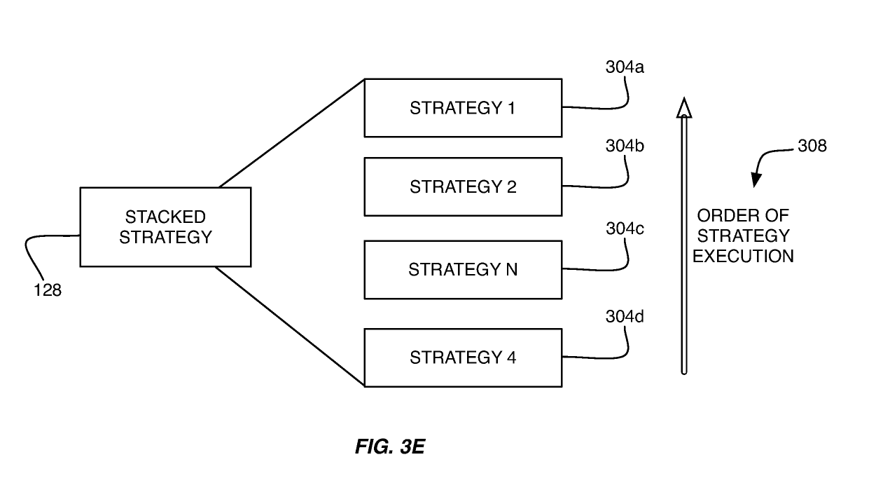

Referring now to FIGS. 3A-3E, various configurations of stacked strategies 128 will be described in accordance with at least some embodiments of the present disclosure. As shown in FIG. 3A, a first stacked strategy 128 configuration is depicted whereby multiple strategies 304a-d are executed in a particular strategy execution order 308. In some embodiments, the strategies 304a-d may correspond to executable strategies 124, 204. Some of the strategies 304a-d in the stacked strategy 128 may comprise a plurality of tasks 212a-M whereas other strategies 304a-d in the stacked strategy 128 may comprise a single task 212.

As shown in FIG. 3B, the stacked strategy 128 may be modified by adjusting the hierarchical order of strategies 304a-d. In the illustrative example, Strategy N and Strategy 2 exchanged positions such that Strategy N became the second strategy 304b and Strategy 2 became the third strategy 304c executed according to the order of strategy execution 308.

As shown in FIG. 3C, the stacked strategy 128 can also be modified by removing a strategy from the set of strategies. Specifically, in the example of FIG. 3C, the second strategy 304b was removed such that the third strategy 304c is executed after the first strategy 304a.

As shown in FIG. 3D, the stacked strategy 128 can also be modified by adding a strategy to the set of strategies. Specifically, in the example of FIG. 3D, a new strategy was added as the first strategy 304a, thereby moving the other strategies further down in the order of execution. It should be appreciated that a strategy can be added to any position in the stacked strategy 128 (e.g., first, middle, or end).

As shown in FIG. 3E, the stacked strategy 128 can also be modified by changing the order of strategy execution 308. Specifically, in the example of FIG. 3E, the order of strategy execution 308 is reversed.

While various examples of modifying a stacked strategy 128 were depicted in FIGS. 3A-E, it should be appreciated that any combination of the modifications can be performed without departing from the scope of the present disclosure. It should further be appreciated that the stacked strategy 128 can be modified alone or with other stacked strategies. Specifically, a single modification instruction received from the administrator device 136 may cause a plurality of stacked strategies 128 to be modified in substantially the same way (e.g., have a new strategy added thereto, removed therefrom, etc.).

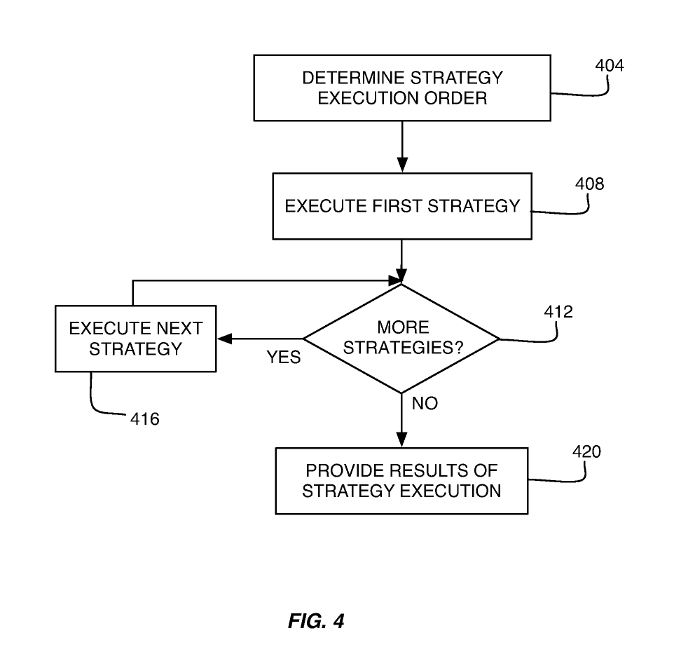

With reference now to FIG. 4, a first method of strategy stacking will be performed in accordance with at least some embodiments of the present disclosure. The method begins by determining an order of strategy execution 308 (step 404). Thereafter, a first strategy 304a in the stacked strategy 128 is executed by the work assignment engine 120 (step 408). In this particular step, each of the tasks 212 defined for a strategy 124, 204 are performed either in accordance with rules 216, 220 contained within the strategy 124, 204 or in accordance with a particular order of the tasks 212a-M as contained within the strategy 204.

After the first strategy 304a has been executed, the method continues with the work assignment engine 120 determining whether more strategies are contained in the stacked strategy 128 (step 412). If the query is answered affirmatively, then the work assignment engine 120 continues by executing the next strategy in accordance with the order of strategy execution 308 (step 416). Once the next strategy has been executed, the method returns to step 412 to determine if further strategies require execution.

After all strategies in the stacked strategy 128 have been executed by the work assignment engine 120, the method proceeds with the work assignment engine providing results of executing the stacked strategy 128 (step 420). Examples of results that may be returned by the work assignment engine 120 include assigning a work item to a resource 112, changing a state of a resource 112, changing a state of a work item, etc. In some embodiments, the results of strategy execution may simply correspond to the work assignment engine 120 performing each task 212 defined in the stacked strategy 128. As can be appreciated, the tasks performed by the work assignment engine may be singular or plural, depending upon the tasks defined within the stacked strategy 128.

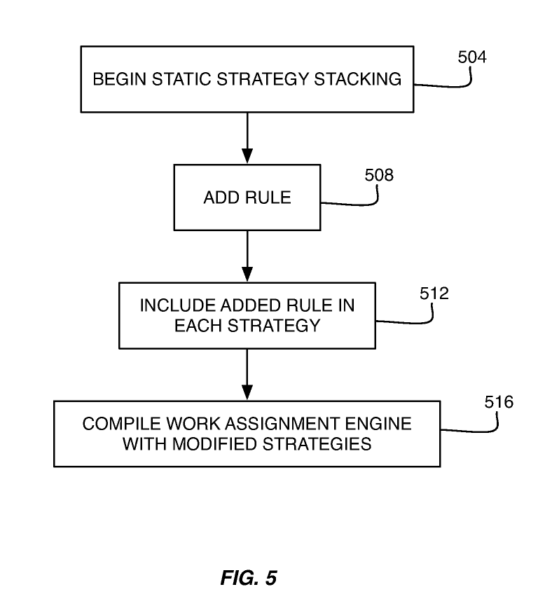

With reference now to FIG. 5, a second method of strategy stacking will be described in accordance with at least some embodiments of the present disclosure. The method, in some embodiments, begins with a decision to begin static strategy stacking (step 504). The decision to begin static strategy stacking may be made by an administrator operating the administrator device 136 and may be communicated to the work assignment engine 120. The method proceeds with the addition of a rule or task (step 508). As can be appreciated, the method may alternatively or additionally comprise modifying a rule or task, as a non-limiting example.

Continuing the example of an added rule, the method continues with the added rule being included into each strategy 124, 204 in the contact center (step 512). In some embodiments, the added rule may be added to each strategy automatically by referencing a file that contains the added rule. Once the new rule has been added, the new rule is finally incorporated into the executable strategies 124 of the work assignment engine 120 by compiling the code of the work assignment engine 120 (step 516). In this way, the newly added rule is now included in each of the strategies 124 of the work assignment engine 120.

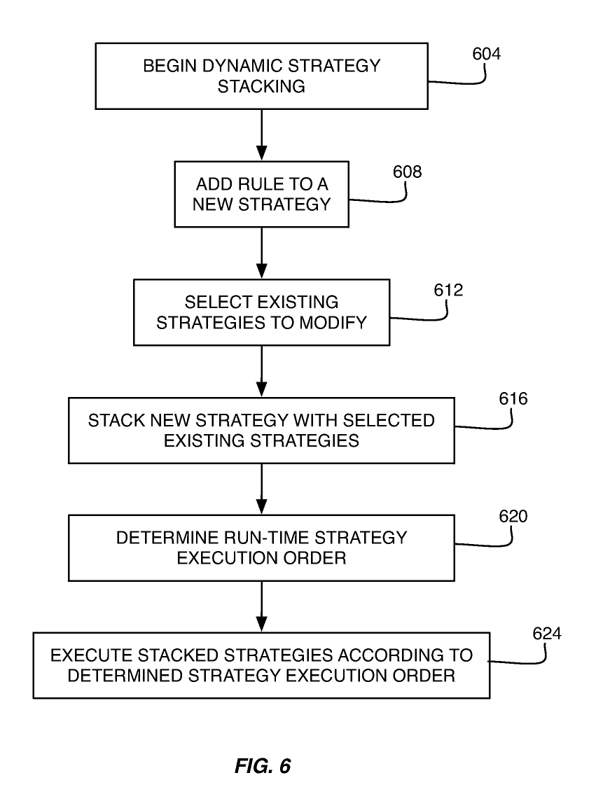

With reference now to FIG. 6, a third method of strategy stacking will be described in accordance with at least some embodiments of the present disclosure. The method begins with a decision to begin dynamic strategy stacking (step 604). As with the decision to begin static strategy stacking, this decision may be made by a contact center administrator.

The method continues by adding a rule or task that was not previously defined within at least one strategy 124, 204 (step 608). After the rule has been defined, the method continues with the selection of which strategies 124, 204 will receive the newly-added rule (step 612). In some embodiments, the strategy may be selected by a contact center administrator directly or automatically in response to a strategy meeting some criteria defined by a contact center administrator.

Once the strategy or strategies have been selected, the method continues by stacking the new strategy containing the newly-added rule (or a new strategy) to the strategy or strategies selected in step 612 (step 616). As a part of stacking the new strategy with other strategies, a run-time order for the stacked strategy is determined (step 620) and then the stacked strategy 128 is executed according to the determined execution order 308 (step 624).

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
stacking a first strategy with a second strategy to create a stacked strategy, wherein the first strategy corresponds to a first set of executable tasks performable by a work assignment engine of a contact center and the second strategy corresponds to a second set of executable tasks performable by the work assignment engine; and
executing the stacked strategy with the work assignment engine according to an order in which the first strategy is stacked with the second strategy.

2. The method of claim 1, wherein the order in which the first strategy is stacked with the second strategy dictates that the first strategy is executed before the second strategy.

3. The method of claim 2, wherein each task in the first set of executable tasks are performed before any task in the second set of executable tasks.

4. The method of claim 1, wherein the first set of executable tasks comprises a plurality of tasks.

5. The method of claim 4, wherein the first strategy further comprises a rule set which defines one or more conditions associated with processing the plurality of tasks in the first set of executable tasks.

6. The method of claim 5, wherein the one or more conditions comprise at least one of conditions related to previously-processed tasks, conditions related to a contact center state, and conditions related to a resource status.

7. The method of claim 4, wherein the plurality of tasks in the first set of executable tasks are hierarchically ordered and wherein the plurality of tasks are performed according to their position within the hierarchical order.

8. The method of claim 1, further comprising:
receiving a new rule associated with the execution of a strategy;
determining that the new rule is to be added to at least one of the first and second strategy; and
incorporating the new rule into the at least one of the first and second strategy.

9. The method of claim 8, further comprising:
compiling the stacked strategy such that the work assignment engine follows the new rule when executing the stacked strategy.

10. The method of claim 1, wherein the first set of executable tasks and the second set of executable tasks comprises at least one task associated with changing a status of a contact center entity.

11. The method of claim 10, wherein the contact center entity comprises at least one of a contact center resource, a work item, and a service.

12. A non-transitory computer readable medium having stored thereon instructions that cause a computing system to execute a method, the instructions comprising:
instructions configured to stack a first strategy with a second strategy to create a stacked strategy, wherein the first strategy corresponds to a first set of executable tasks performable by a work assignment engine of a contact center and the second strategy corresponds to a second set of executable tasks performable by the work assignment engine; and
instructions configured to execute the stacked strategy with the work assignment engine according to an order in which the first strategy is stacked with the second strategy.

13. The computer readable medium of claim 12, wherein the order in which the first strategy is stacked with the second strategy dictates that the first strategy is executed before the second strategy and wherein each task in the first set of executable tasks are performed before any task in the second set of executable tasks.

14. The computer readable medium of claim 12, wherein the first set of executable tasks comprises a plurality of tasks.

15. The computer readable medium of claim 14, wherein the first strategy further comprises a rule set which defines one or more conditions associated with processing the plurality of tasks in the first set of executable tasks.

16. The computer readable medium of claim 15 wherein the one or more conditions comprise at least one of conditions related to previously-processed tasks, conditions related to a contact center state, and conditions related to a resource status.

17. The computer readable medium of claim 14, wherein the plurality of tasks in the first set of executable tasks are hierarchically ordered and wherein the plurality of tasks are performed according to their position within the hierarchical order.

18. The computer readable medium of claim 12, wherein the first set of executable tasks and the second set of executable tasks comprises at least one task associated with changing a status of a contact center entity.

19. A contact center, comprising:
a work assignment engine configured to execute a stacked strategy that comprises a plurality of individual strategies, each of the individual strategies comprising discrete tasks and one or more rules defining conditions for performing the discrete tasks, wherein the work assignment engine executes the stacked strategy in accordance with an order in which individual strategies are stacked such that discrete tasks from a first individual strategy are performed before discrete tasks from a second individual strategy.

20. The contact center of claim 19, wherein the stacked strategy is configured to be at least one of statically and dynamically stacked with an additional strategy.
